(19) United States
(12) Patent Application Publication
(10) Pub. No.: US 2025/0173607 A1
(43) Pub. Date: May 29, 2025

(54) ACTIONABLE INSIGHT GENERATION FOR INCIDENTS GENERATED FROM EVENTS

(71) Applicant: BMC Software, Inc., Houston, TX (US)

(72) Inventors: Priya Saurabh Talwalkar, Pune (IN); Ajoy Kumar, Santa Clara, CA (US); Eric Michael Anderson, Friendswood, TX (US)

(21) Appl. No.: 18/523,804

(22) Filed: Nov. 29, 2023

(51) Int. Cl. G06N 20/00

(52) U.S. Cl. CPC G06N 20/00

(57) ABSTRACT

A plurality of resolved incident tickets of a technology landscape may be received from an incident handling system. A plurality of events may be received from a metric monitoring system monitoring the technology landscape. An incident cluster having related incidents may be generated from the plurality of resolved incident tickets, and a correlated event of the plurality of events may be identified for the incident cluster. The correlated event may be stored with an incident resolution obtained from the incident cluster, to obtain labeled training data. A machine learning (ML) model may be trained with the labeled training data to obtain an incident prediction model. A new event may be processed with the incident prediction model to provide a predicted incident and a predicted resolution.

### TECHNICAL FIELD

This description relates to incident and event handling in Information Technology (IT) environments.

### BACKGROUND

Information Technology (IT) incident handling generally refers to, or includes, structured processes followed by organizations or other entities to restore various IT services to specified or desired operating levels. For example, an incident may refer to an experience of a user in which the user fails to obtain an anticipated feature of an IT resource or receives an unanticipated failure of an IT resource.

Meanwhile, event monitoring refers to techniques designed to detect, predict, prevent, mitigate, or cure system faults that might otherwise disrupt or prevent monitored IT assets from achieving system goals. For example, it is possible to monitor various types of performance metrics characterizing aspects of system performance. When monitored values of the detected performance metrics are scored as being outside of a predetermined range, the monitored values may be considered potentially indicative of a current or future system malfunction, and corresponding action(s) may be taken.

Thus, incident handling generally refers to user-facing interactions of an incident agent, while event monitoring refers more to backend operations of a system administrator overseeing operations of IT resources. Incident handling and event monitoring have areas of overlap since both may relate to the same IT resources. At the same time, many incidents are completely independent from event monitoring (e.g., incidents caused by user error), while many events may not result in occurrence of an incident experienced by a user (e.g., events for which redundant resources are available).

Consequently, it may be difficult for an incident agent to be aware of events that may assist the incident agent in resolving a current incident. Likewise, it may be difficult for a system administrator to determine whether a current event is currently causing, or likely to lead to, an incident experienced by a user.

### SUMMARY

According to one general aspect, a computer program product may be tangibly embodied on a non-transitory computer-readable storage medium and may include instructions that, when executed by at least one computing device, are configured to cause the at least one computing device to receive, from an incident handling system, a plurality of resolved incident tickets of a technology landscape, and receive, from a metric monitoring system monitoring the technology landscape, a plurality of events. The instructions, when executed by at least one computing device, are configured to cause the at least one computing device to generate, from the plurality of resolved incident tickets, an incident cluster having related incidents, identify, for the incident cluster, a correlated event of the plurality of events, and store the correlated event with an incident resolution obtained from the incident cluster, to obtain labeled training data. The instructions, when executed by at least one computing device, are configured to cause the at least one computing device to train a machine learning (ML) model with the labeled training data to obtain an incident prediction model and process a new event with the incident prediction model to provide a predicted incident, the potential cause or event, and a predicted resolution.

According to other general aspects, a computer-implemented method may perform the instructions of the computer program product. According to other general aspects, a system may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of system for actionable insight generation for incidents generated from events.

FIG. 2 is a flowchart illustrating example operations of the system of FIG. 1.

FIG. 3 is a block diagram illustrating an example implementation of the system of FIG. 1.

FIG. 4 is a first example knowledge graph generated using the techniques of FIGS. 1-3.

FIG. 5 is a second example knowledge graph generated using the techniques of FIGS. 1-3.

FIG. 6 is a third example knowledge graph generated using the techniques of FIGS. 1-3.

FIG. 7 is a fourth example knowledge graph generated using the techniques of FIGS. 1-3.

FIG. 8 is a flowchart illustrating example techniques for generating the knowledge graphs of FIGS. 1 and 3-7.

FIG. 9 illustrates an example context for implementation of a resolution generator of the system of FIG. 1.

FIG. 10 illustrates example techniques for implementing the flowchart of FIG. 8, including performing paraphrase mining on resolution statements of FIG. 9.

FIG. 11 is a block diagram illustrating a first example of resolution statement analysis.

FIG. 12 is a block diagram illustrating a second example of resolution statement analysis.

FIG. 13 is a block diagram illustrating a third example of resolution statement analysis.

### DETAILED DESCRIPTION

Described systems and techniques provide fast and accurate triage and resolution of received incident tickets, based at least in part on tracked knowledge of corresponding event metrics. Described techniques further provide system administrators monitoring event metrics with information regarding current and future incident-related events. Consequently, incidents may be reduced and/or quickly resolved by incident agents, while system administrators may administer monitored IT resources in an efficient, effective manner, including prioritizing resources and preventing or reducing occurrences of future incidents.

As referenced above, IT incidents may relate to virtually any issue, problem, or difficulty experienced by a user of an IT resource of an IT landscape. For example, a user experiencing an incident may be a customer of a business providing access to an IT landscape (e.g., in an ecommerce scenario), or may be an employee of a provider of the IT landscape (e.g., an employee working remotely).

Many other examples of such users would be apparent, some of which are described in more detail, below, for the sake of further example and explanation. In many such cases, a source of the incident may be, or may be related to, user error or user ignorance. For example, the user may be locked out of the user's account because an incorrect password was provided too many times, or the user may have incorrect settings on the user's local computer. In other scenarios, however, the user may experience an error that is clearly caused by a system malfunction or event rather than user error, such as when a website is down in conjunction with a server crash.

For a system administrator, a monitoring system may generate events detected in an IT landscape at a high frequency and for a large number of both software and hardware IT resources. For example, such events may include various types of detected latencies, hardware memories that are approaching (or that have reached) capacity, or components that have failed and gone off-line. Furthermore, such events cause other events downstream, with the impact experienced by many and varied components downstream of a causal event. Individual ones of such events may be clearly associated with the likelihood of a corresponding user incident being reported, such as in the example above of a crashing server.

In some cases, however, individually detected events may have no immediate impact on larger-scale system performance, or on users' experiences. For example, multiple events may be detected and corresponding alarms issued, but many such events resolve on their own. Others of these events may be easily handled individually but may be difficult to handle if an overall number of events is large. Often a combination or progression of events may lead to a malfunction(s), which may ultimately result in an incident experienced by a user.

Thus, the job of the system administrator in these contexts is to recognize, identify, and correct small problems before they become larger and/or more problematic, alone or in combination with other problems. Rules or guidelines may exist to assist the system administrator in these contexts, such as designating that a given set of IT resources is associated with a higher priority than other IT resources. Nonetheless, conventional techniques do not adequately relate user incidents with performance metrics of events in a manner that enables incident agents and/or system administrators to perform their duties to a desired level.

Described techniques cluster related incidents together to derive knowledge and insight with respect to causes, symptoms, and resolutions of incidents, which may then be visually represented in a knowledge graph that assists incident agents in performing their duties. Additionally, such incident clusters may be related to, or correlated with, any corresponding events within the same technology landscape.

As a result, incident agents may be facilitated in resolving newly received incidents. For example, if a new incident is related to a recent/current event, then the incident agent may use information regarding the event to resolve the incident for the user, or at least may be enabled in alerting the user regarding the nature of the event and the likely time to resolution thereof. If the new incident is not related to a recent/current event, the incident agent may also benefit from such information, e.g., may be alerted to focus on potential user error to resolve the incident.

Meanwhile, a system administrator reviewing new events may be facilitated in prioritizing events for resolution. For example, the system administrator may be alerted with respect to the potential number of users who will be impacted by the causal event and events likely to lead to incidents, or currently causing an incident.

Still further, resolutions generated in conjunction with the types of knowledge graphs just referenced may be correlated with corresponding events to thereby obtain training data for training an incident prediction model. Once trained, the incident prediction model may be deployed for use by both the incident agent and the system administrator. For example, the incident agent may be provided with notifications of impending incidents, along with potential resolutions for the incidents. Similarly, the system administrator 121 may gain additional information to use in prioritizing and remediating events likely to lead to current/future incidents.

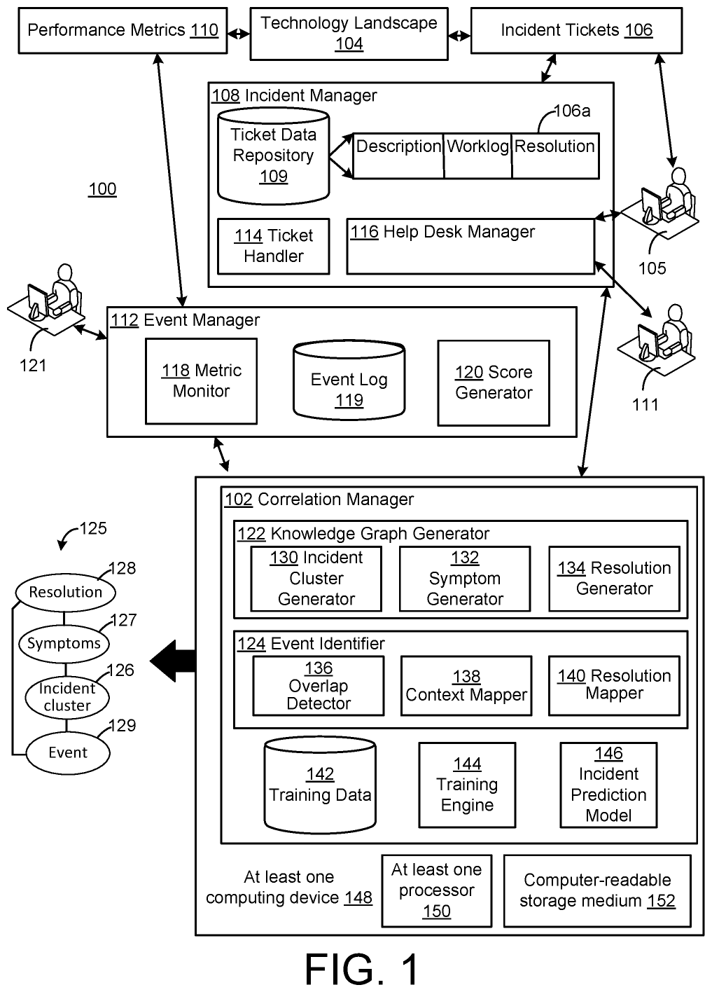

FIG. 1 is a block diagram of system 100 for actionable insight generation for incidents generated from events. In FIG. 1, a correlation manager 102 is configured to provide the types of incident and/or event processing described above, to enable both enhanced incident handling and enhanced event handling.

In FIG. 1, a technology landscape 104 may represent any suitable source of incident tickets 106, submitted by various users represented in FIG. 1 by a user 105, that may be processed by an incident manager 108. Meanwhile, performance metrics 110 characterizing the technology landscape 104 may be collected and processed by an event manager 112.

In more detail, the incident manager 108 may be configured to receive the incident tickets 106 over time at a ticket handler 114, for storage using a ticket data repository 109. Handling of the incidents may be performed using a help desk manager 116, representing suitable software (e.g., graphical user interface (GUI)) for facilitating actions of, and/or interactions between, the user 105 and/or an incident agent 111.

Performance metrics 110 may be collected over time at the event manager 112 by a metric monitor 118. An event log 119 may be used to store events determined in conjunction with corresponding metric scores provided by a score generator 120, which may then be evaluated by a system administrator 121 to determine appropriate action(s) to be taken with respect to the technology landscape 104.

In example contexts and implementations, the technology landscape 104 may include many types of network environments, such as network administration of a private or local area network of an enterprise, or an application provided over the public internet or other network. Technology landscape 104 may also represent scenarios in which sensors, such as internet of things devices (IoT), are used to monitor environmental conditions and report on corresponding status information (e.g., with respect to patients in a healthcare setting, working conditions of manufacturing equipment or other types of machinery in many other industrial settings (including the oil, gas, or energy industry), or working conditions of banking equipment, such as automated transaction machines (ATMs)). In some cases, the technology landscape 104 may include, or reference, an individual IT component, such as a laptop or desktop computer or a server. In some embodiments the technology landscape 104 may represent a mainframe computing environment, or any computing environment of an enterprise or organization conducting network-based IT transactions.

The incident tickets 106 may thus represent any tickets related to any incident that may be experienced by the user 105 with respect to any of the various hardware or software components just referenced. In addition, as already noted, the incident tickets 106 may represent incidents occurring in any suitable context other than the technology landscape 104, for which incident resolution may be facilitated by the associated incident agent 111.

FIG. 1 illustrates that an individual incident ticket 106a of the incident tickets 106 may include multiple fields for storing associated types of data. In the example, the individual incident ticket 106a includes a description field, a worklog field, and a resolution field, which are thus designated for containing associated types of ticket content for the individual incident ticket 106a. Although other terminology may be used for such ticket fields, additional or alternative ticket fields may be included as well, as described below. The individual incident ticket 106a illustrates that ticket content for an individual incident ticket 106a may be accumulated over time during the lifecycle of the individual incident ticket 106a in question.

For example, when the individual incident ticket 106a is first submitted by the user 105, the user 105 may be required to provide content for the description field, to provide context and explanation for the incident the user 105 is experiencing. The description may be brief and/or may be detailed, or there may be separate fields for brief/detailed descriptions.

The worklog field refers to an audit history of actions of, and interactions between, the user 105 and the incident agent 111, during the lifecycle of the individual incident ticket 106a. The worklog may include attempted resolutions performed by the incident agent 111, messages (e.g., emails or chat messages) between the user 105 and the incident agent 111, or written or auto-transcribed text of audio communications between the user 105 and the incident agent 111. The worklog may also include interactions between the incident agent 111 and other incident agents, or between the incident agent 111 and external sources of potential resolutions for the incident in question, such as knowledge base (KB) articles or various resources available on the internet.

The resolution field is designed and intended to include a resolution of the incident that caused the individual incident ticket 106a to be generated. For example, the incident agent 111 may be responsible for entering whatever resolution was ultimately responsible for satisfying the user 105 and closing the individual incident ticket 106a. Once the individual incident ticket 106a is resolved and closed, the individual incident ticket 106a may be stored in the ticket data repository 109, as already referenced.

To the extent that the resolution field is required to be filled by a human incident agent 111, it becomes possible that the resolution field of the individual incident ticket 106a will be filled out incorrectly or incompletely. For example, it may occur that the incident agent 111 is required to handle a large volume of the incident tickets 106, perhaps in an overlapping fashion and/or within a relatively short period of time, and perhaps across multiple applications or other use case scenarios. Consequently, once the individual incident ticket 106a is resolved, the incident agent 111 may be eager to complete the individual incident ticket 106a and move on to another one of the incident tickets 106.

For these and other reasons, the incident agent 111 may be prone to providing insufficient, incomplete, or incorrect content within the resolution field of the individual incident ticket 106a (resolution content). For example, the incident agent 111 may leave the resolution field blank. Even if the help desk manager 116 implements a requirement for the incident agent 111 to fill out the resolution field, the incident agent 111 may circumvent this requirement by entering some minimum quantity of data, such as “incident resolved,” needed to close the individual incident ticket 106a.

For example, the user 105 may submit the individual incident ticket 106a via a suitable GUI of the help desk manager 116, together with a description of the incident in the description field. The user 105 and the incident agent 111 may then work (together or separately) on resolving the incident, while simultaneously compiling corresponding worklog content for the worklog field of the individual incident ticket 106a. Thus, over time, the ticket data repository 109 may accumulate a plurality of resolved incident tickets and/or incident tickets that are in progress.

With respect to the performance metrics 110, it will be appreciated that various types of performance metrics for corresponding IT assets/resources may be defined. Although widely varying in type, a common scoring system across all of the performance metrics 110 may be used in some implementations for all such performance metrics, for ease and consistency of comparison of current operating conditions (e.g., for detecting events and anomalies and/or generating alarms).

For example, some performance metrics may include performance metrics commonly referred to as key performance indicators, or KPIs. The term KPI should be understood broadly to represent or include any measurable value that can be used to indicate a past, present, or future condition, or enable an inference of a past, present, or future condition with respect to a measured context (including, e.g., the example contexts referenced below). KPIs are often selected and defined with respect to an intended goal or objective, such as maintaining an operational status of a network or providing a desired level of service to the user 105. For example, KPIs may include a percentage of central processing unit (CPU) resources in use at a given time, an amount of memory in use, or data transfer rates or volumes between system components.

In a given IT system, the system may have hundreds or even thousands of KPIs that measure a wide range of performance aspects about the system and its operation. Consequently, the various KPIs may, for example, have values that are measured using different scales, ranges, thresholds, and/or units of measurement.

Through the use of the score generator 120, one or more machine learning models may be trained to account for these and other factors and to assign a score to a value or values of a specific KPI or group of KPIs at a given time. Individually or in the aggregate, these scores may be used to provide a performance characterization of the technology landscape 104, or a portion or portions thereof. Moreover, the scores may be defined with respect to a scale, range, threshold(s), and/or unit of measurement that may be commonly defined across all KPIs. As a result, it is possible to assess and otherwise utilize the resulting individual scores, even for a large number of KPIs.

Such scores may change frequently over time. A dashboard or other visual representation provided by the score generator 120 may display tens, hundreds, or thousands of scores of all available KPI or KPI groups, with scores being updated every minute, every five minutes, or according to any suitable schedule. Therefore, a person viewing such a visual representation may be faced with a sea of changing score values and may find it difficult to discern any actions to be taken in response thereto.

Some existing systems may assign importance levels to KPIs, KPI groups, or KPI scores, in order to assist users in deploying IT assets or other resources. Based on the assigned importance levels, the user 105 may prioritize evaluations of anomalous scores reported. Based on the assigned importance levels, it is possible to configure generation of alerts and alarms with respect to specific KPIs, KPI groups, or KPI scores. Such importance levels, alerts, and alarms may be helpful in many scenarios, but may not be helpful in other scenarios, such as when multiple anomalies have similar importance levels, or when many alerts or alarms are generated at once.

The performance metrics 110 may thus represent any corresponding type(s) of data that is captured and reported, particularly in an ongoing, dynamic fashion, and for a potentially large number of performance metrics. For example, in a setting of online sales or other business transactions, the performance metrics 110 may characterize a condition of many servers being used. In a healthcare setting, the performance metrics 110 may characterize either a condition of patients being monitored or a condition of IoT sensors being used to perform such monitoring. Similarly, the performance metrics 110 may characterize machines being monitored, or IoT sensors performing such monitoring, in manufacturing, industrial, energy, or financial settings.

In FIG. 1, the metric monitor 118 receives the performance metrics 110 over time, e.g., in real time. The performance metrics 110 may be monitored in a manner that is particular to the type of underlying IT asset or resource being monitored. For example, received values (and value ranges) and associated units of measurement may vary widely, depending on whether, for example, an underlying resource includes processing resources, memory resources, or network resources (e.g., related to network bandwidth, or latency).

The score generator 120, as referenced above, may score various performance metric values received through the metric monitor 118 to obtain standardized performance characterizations that are interpretable by system administrator(s) 121 and other users, and that may be used in conjunction with one another to provide a multivariate analysis of desired aspects of the technology landscape 104.

For example, in some scoring systems, threshold values may be set such that scores above or below zero within a first threshold (e.g., from −1.5 to 1.5 in a first approach, or from −3.0 to 3.0 in a second approach) are considered “green,” or acceptable; scores outside of the first threshold but within a second threshold (e.g., from −3.0 to −1.5 and from 1.5 to 3.0 in the first approach, or from −6 to −3 and from 3 to 6 in the second approach) are considered “yellow,” or cautionary; and scores outside of the second threshold (e.g., less than −3 or more than 3 in the first approach, or less than −6 or more than 6 in the second approach) are considered “red” or anomalous. In similar scoring schemes, other thresholds may be set. For example, an outer (“red”) range may be set as less than −3.0 or more than 3.0, or less than −1.5 or more than 1.5.

In additional or alternative scoring schemes, performance metric values may be normalized for scoring between 0 and 100 (or some other minimum or maximum value), where either 0 or 100 may be selected as an optimal value. Then, ranges within the 0 to 100 range may be designated as stable or “green,” warning or “yellow,” or critical or “red.”

These approaches are merely examples, and, as described herein, other scoring values, ranges, and thresholds may be set. Thus, the scores provided by the score generator 120 may effectively represent what is normal or expected for the particular environment of the technology landscape 104. As a result, such scores may be understood to provide, for example, a measure of an extent to which a raw value differs from its modeled mean in terms of standard deviation units. In such examples, the above-referenced scores of ±1.5 represent 1.5 standard deviations from the mean, and the scores of ±3.0 represent 3 standard deviations from the mean. Model sensitivity levels may be set to dictate values of a normal range and the ranges of levels of deviation.

As referenced, many other types of scoring techniques may be used than the examples provided above. Regardless of a specific technique used, scoring of performance metrics 110 results in large numbers of scores being assigned to many different performance metrics. Therefore, there may be many different scores generated at a point in time that simultaneously indicate potential anomalies, faults, or other types of problems, generally referred to herein as events. Consequently, it may be difficult to discern which score (and underlying IT asset) should be addressed to implement system maintenance or repair in an efficient and effective manner.

In order to enhance operations of the incident manager 108 and the event manager 112, and to enhance an efficiency and experience of the user 105, the incident agent 111, and/or the system administrator 121, the correlation manager 102 may be configured to generate actionable insights for incidents generated from events. That is, as referenced above, and described in more detail, below, the correlation manager 102 may be configured to provide event-related information to the incident agent 111 to assist in handling corresponding ones of the incident tickets 106, while providing incident-related information to the system administrator 121 to assist in selecting, prioritizing, and remediating events related to the performance metrics 110 and stored using the event log 119.

For example, the correlation manager 102 is illustrated as including a knowledge graph generator 122, which may be configured to generate a knowledge graph 125 relating incidents, incident symptoms, and incident resolutions. The resulting knowledge graph 125 may be used by the incident agent 111 to triage and resolve newly received ones of the incident tickets 106.

The correlation manager 102 may also include an event identifier 124. The event identifier 124 may be configured to relate one or more events to one or more incidents of the knowledge graph 125 provided by the knowledge graph generator 122.

In more detail, the knowledge graph generator 122 may include an incident cluster generator 130 that is configured to process incident tickets 106 of the incident ticket data repository 109 to identify and group related incident clusters, an example of which is represented in the knowledge graph 125 as a node labeled as an incident cluster 126. For example, the incident cluster generator 130 may identify the incident cluster 126 based on a semantic similarity analysis of content of incident tickets, overlapping times or related contexts in which groups of incident tickets are received, or various other clustering techniques, some of which are described below in more detail.

A symptom generator 132 may be configured to analyze incident tickets of the incident cluster 126 and determine and classify one or more common symptoms, shown in the knowledge graph 125 as a node labeled symptoms 127. For example, incident tickets of incidents of the incident cluster 126 may have one symptom (e.g., cause or characteristic) that is common to all of the incidents, or may have two or more types of symptoms that are each common to a subset of the incidents of the incident cluster 126.

Similarly, a resolution generator 134 may be configured to analyze the incident tickets of the incident cluster 126 to determine a resolution 128 (e.g., solution, fix, or remediation) that is common to all of the incidents, or two or more resolutions that are each common to a subset of the incidents of the incident cluster 126. Although not shown in the simplified example of FIG. 1, it will be appreciated that individual resolutions corresponding to particular subsets of incident tickets of the incident cluster 126 may be related to one or more symptoms of the same subsets. In other words, there may be a one-to-one, one-to-many, many-to-one, or many-to-many relationship(s) between the resolution(s) 128 and the symptom(s) 127.

The event identifier 124 may use one or more techniques to relate one or more events to the incident cluster 126, shown in FIG. 1 as inclusion of a node labeled event 129 in the knowledge graph 125. For example, the event identifier 124 may include an overlap detector 136 that detects an overlap in time between occurrence of an incident of the incident cluster 126 and the event 129.

For example, the overlap detector 136 may determine that, for each incident of the incident cluster 126, a corresponding event represented by the event 129 occurs within a threshold overlap time prior to the relevant incident ticket being received. The threshold overlap time may be set to any suitable threshold, which may vary based on, e.g., a type of incident and/or a type of event being considered, and/or may be selected as a design parameter intended to minimize false positives or false negatives, or achieve any other suitable design goal.

Moreover, it is not necessary that all of the incident tickets of the incident cluster 126 be associated with a corresponding instance of the event 129. For example, the incident cluster 126 may include 50, 100, 300, or more incident tickets, and a separate percentage threshold may be set to determine whether to identify the event 129 with the incident cluster 126 within the knowledge graph 125. For example, if at least 75%, 85%, or other suitable threshold of incidents occur within the overlap window for corresponding event instances of the event 129, then the overlap detector 136 may determine that incident/event overlap has occurred.

A context mapper 138 may be configured to map a context of each incident with a corresponding context of event instances being examined by the event identifier 124. For example, the incident tickets of the incident cluster 126 may all relate to a particular configuration item (CI) of the technology landscape 104, defined by ITIL®, for example, as a component that fulfills an end-use function, has separate needs, or capabilities, and is assigned for unique control in a configuration-management system. The event 129 being considered may also occur with respect to the same CI.

More generally, the context of an incident of the incident cluster 126 and/or event 129 refers to any characteristic of an IT resource involved in the incident and/or event 129. For example, context may refer to a business context (e.g., occurring within a single business unit), or other organizational characteristic of the technology landscape 104.

The event identifier 124 may also include a resolution mapper 140, which may be configured to relate a determined resolution 128 with the event 129, as shown in the knowledge graph 125. In other words, such a resolution mapping recognizes and leverages the fact that a resolution 128 of an incident may also resolve a corresponding event 129, and, conversely, a resolution 128 of an event 129 may also resolve a corresponding incident.

The event identifier 124 may utilize a combination of outputs of the overlap detector 136, the context mapper 138, and the resolution mapper 140 to determine whether to include the event 129 in the knowledge graph 125. In some instances, the knowledge graph 125 will not include any event related to the incident cluster 126. For example, if the incident cluster 126 relates to the local system of the user 105 running slowly, then the incident cause may be a misconfiguration of the user's local resources (in which case no system event may be included), or may relate to some other IT resource within the IT technology landscape 104 that is communicating with the user's system while operating beyond some relevant capacity (in which case an event related to such an IT resource may be included). Therefore, when reviewing a new incident ticket that is related to the incident cluster 126, the use of the knowledge graph 125 may immediately alert the incident agent 111 as to whether a related event is likely to be causal, as compared to some local error of the user 105.

Additionally, the relation of the event 129 to the incident cluster 126 and to the resolution 128 provides an instance of training data to be included within training data 142. Then, a training engine 144 may be configured to train a suitable model, such as a regression model, to obtain an incident prediction model 146.

In other words, and as described in more detail, below, a volume of event/incident/resolution training data may be accumulated from many instances of the knowledge graph 125 and used by the training engine 144 to train the incident prediction model 146. That is, the training data 142 represents a set of labelled training data used for implementing a supervised machine learning algorithm.

As a result, when the event manager 112 determines a newly received, current event, the incident prediction model 146 may be used to process the received event and predict whether, how, and when a corresponding incident ticket might be likely to be received. A corresponding resolution may be generated that will mitigate the event and prevent or mitigate the corresponding incident. Consequently, the user 105 and the incident agent 111 may be relieved from ever having to deal with the predicted incident, or may only deal with a mitigated version of the predicted incident.

In some instances, the incident prediction model 146 may be used to alert the incident agent 111 to anticipate the predicted incident. Then, if complete incident avoidance/mitigation is not successful, the incident agent 111 will at least be able to quickly diagnose the incident and/or alert the user 105 as to actions being taken to remedy the event(s) causing the incident experienced by the user 105.

In FIG. 1, the correlation manager 102 is illustrated as being implemented using at least one computing device 148, including at least one processor 150, and a non-transitory computer-readable storage medium 152. That is, the non-transitory computer-readable storage medium 152 may store instructions that, when executed by the at least one processor 150, cause the at least one computing device 148 to provide the functionalities of the correlation manager 102 and related functionalities.

For example, the at least one computing device 148 may represent one or more servers. For example, the at least one computing device 148 may be implemented as two or more servers or virtual machines in communications with one another over a network. Accordingly, the correlation manager 102, the event manager 112, and the incident manager 108 may be implemented using separate devices in communication with one another. In other implementations, however, although the correlation manager 102 is illustrated separately from the incident manager 108 and the event manager 112, it will be appreciated that some or all of the respective functionalities of either the correlation manager 102, the incident manager 108, and/or the event manager 112 may be implemented partially or completely in the other, or in both.

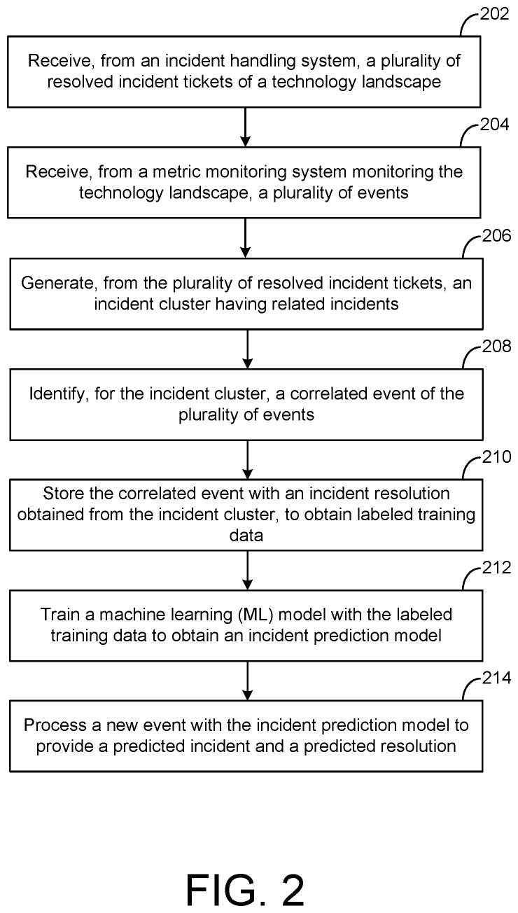

FIG. 2 is a flowchart illustrating example operations of the incident handling system 100 of FIG. 1. In the example of FIG. 2, operations 202 to 214 are illustrated as separate, sequential operations. In various implementations, the operations 202 to 214 may include sub-operations, may be performed in a different order, may be performed iteratively, may include alternative or additional operations, or may omit one or more operations or suboperations.

In the example of FIG. 2, a plurality of resolved incident tickets of a technology landscape may be received from an incident handling system (202). For example, the knowledge graph generator 122 may receive resolved incident tickets from the ticket data repository 109 of the incident manager 108 of FIG. 1, such as the individual incident ticket 106a having its included resolution field completed.

A plurality of events may be received from a metric monitoring system monitoring the technology landscape (204). For example, the event identifier 124 may receive events from the event log 119 of the event manager 112, based on analysis of the performance metrics 110 by the score generator 120.

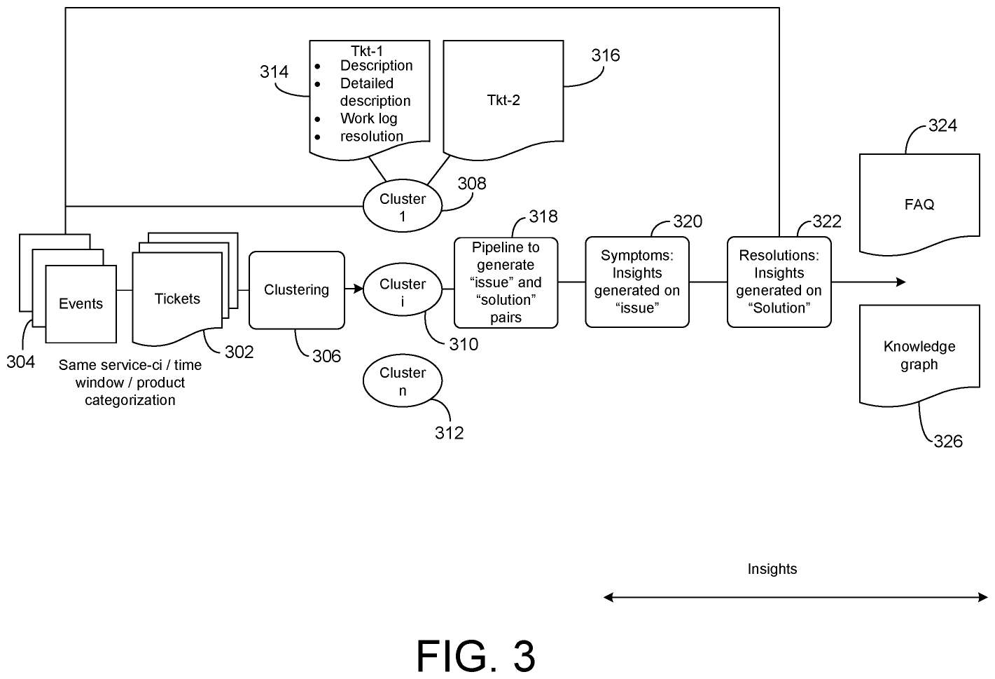

From the plurality of resolved incident tickets, an incident cluster having related incidents may be generated (206). For example, the incident cluster generator 130 may generate the incident cluster 126 of the knowledge graph 125. As referenced above, and described in more detail below with respect to FIG. 3, one or more clustering techniques may be used. For example, clustering may be provided based on the description, worklog, and/or resolution fields of the incident tickets, a source(s) of the incident tickets within the technology landscape 104, and/or overlapping time windows during which the clustered incidents occurred and/or were resolved.

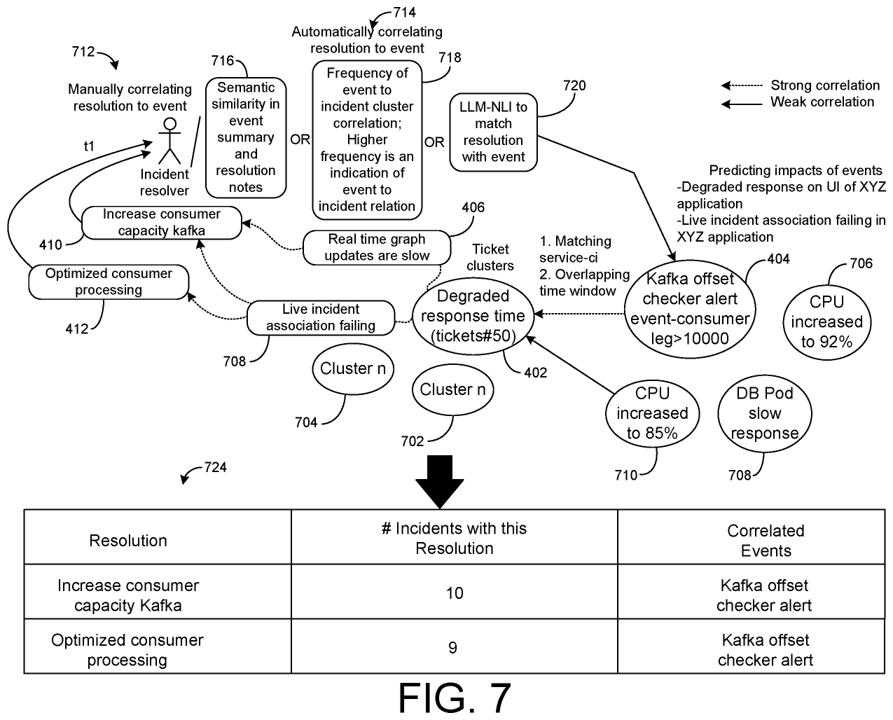

For the incident cluster, a correlated event of the plurality of events may be identified (208). For example, the event identifier 124 may identify the event 129 of the knowledge graph 125 as being related to incidents of the incident cluster 126. Techniques for correlating the event 129 with the incident cluster 126 are referenced above with respect to the overlap detector 136 and the context mapper 138, and are described in more detailed examples below, with respect to FIGS. 3 and 7.

The correlated event may be stored with an incident resolution obtained from the incident cluster, to obtain labeled training data (210). For example, for an individual incident cluster, such as the incident cluster 126 of the knowledge graph 125, the event identifier 124 may identify the event 129 as being related to the resolution 128. Determining such correlations over a large number of knowledge graphs enables population of the training data 142. Techniques for correlating the event 129 with the resolution 128 are referenced above with respect to the resolution mapper 140, and are described in more detailed examples below, with respect to FIGS. 3 and 7.

The machine learning (ML) model may be trained with the labeled training data to obtain an incident prediction model (212). For example, the training engine 144 may use the training data 142 to train and deploy the incident prediction model 146 of FIG. 1.

A new event may be processed with the incident prediction model to provide a predicted incident and a predicted resolution (214). For example, the incident prediction model 146 may be deployed to the incident manager 108 and/or the event manager 112 to provide incident-related insights with respect to newly received ones of the incident tickets 106 and/or newly generated events determined using the score generator 120.

FIG. 3 is a block diagram illustrating an example implementation of the system of FIG. 1. In the example of FIG. 3, incident tickets 302 are received and undergo a clustering process 306 to generate a plurality of incident ticket clusters 308, 310, 312. As described above with respect to FIG. 1, and illustrated in FIG. 3 with respect to the cluster 308, each cluster may include a plurality of tickets 314, 316, each of which may include a brief description, detailed description, worklog, and resolution, as illustrated with respect to the incident ticket 314.

As also shown, a plurality of events 304 may provide a source of events that may be correlated with one or more of the clusters 308, 310, 312. For example, events of the events 304 that overlap in time within a defined time window or threshold, or that relate to a same or similar CI, or that are within a same or similar product categorization, may be correlated with the incident cluster 308.

Meanwhile, a pipeline 318 may be implemented to generate issue and solution pairs for each incident cluster. For example, as described, incident tickets may include brief descriptions, detailed descriptions, worklogs, and resolutions. Any or all of these fields may include multiple types of information that may be unhelpful at best or misleading at worst. For example, worklogs may include suspected problems or solutions that turned out to be incorrect, or may include excess unhelpful verbiage, or may be blank.

Processing the incident tickets of a cluster may thus result in generation of symptoms 320, providing helpful insights based on presented issues found in the brief description, detailed description, or worklog fields. For example, symptoms 320 may be determined and understood based on variations or patterns (e.g., tags) included in the ticket fields. For example, symptoms may be determined based on a frequency of occurrence of repeated issues, or on detection of commonalities related to an environment (e.g., home or work environment), product name, product type, or incident/product category.

Similarly, resolutions 322 may be determined from insights generated on resolution or solution fields. For example, all of the resolutions in a cluster, and included variations from and/or patterns in the resolutions, may be analyzed.

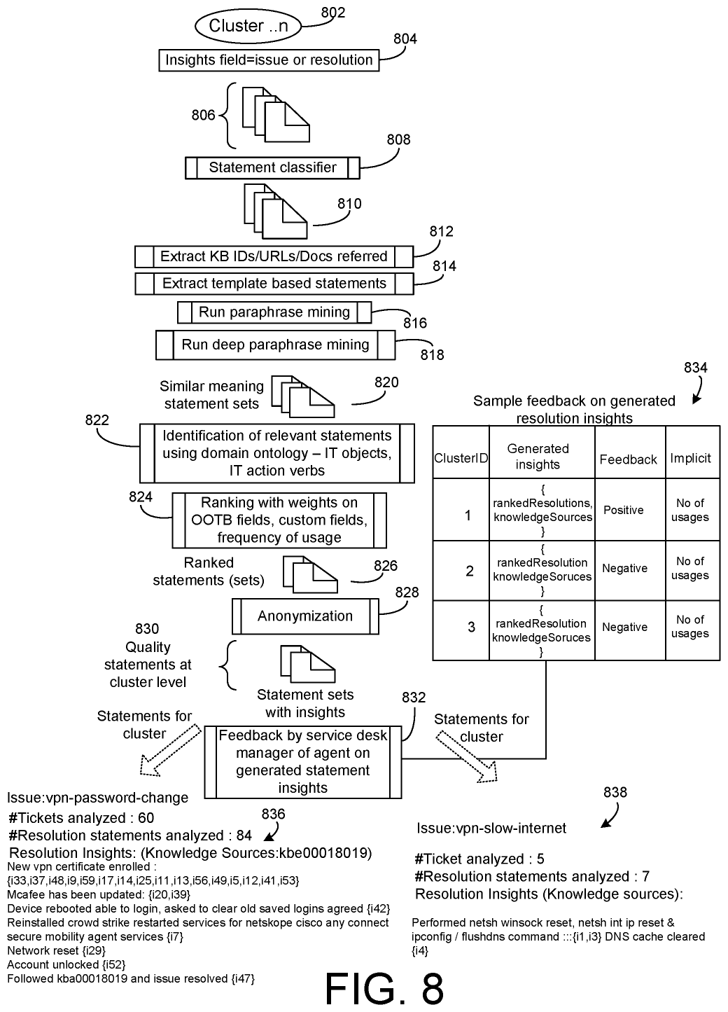

Specific techniques for determining the resolutions 322 are described below in detail with respect to FIGS. 8-13. Techniques similar to those described below in detail with respect to FIGS. 8-13 may be applied to execute the pipeline 318 to determine the symptoms 320, as well.

Further in FIG. 3, insights gained from determining the incident ticket cluster 308, corresponding symptoms 320, and corresponding resolutions 322 may be used to generate a knowledge graph 326, corresponding to the knowledge graph 125 of FIG. 1. As also illustrated, the determined insights from the described incident clusters and pipeline processing may be used to generate FAQs 324 that may also be useful in resolving future incident tickets.

Also in FIG. 3, the relevant events of the events 304 for the cluster 308 may be related to corresponding resolutions of the resolutions 322. As described with respect to FIG. 1, and illustrated and described in more detail, below, with respect to FIG. 7, the resulting event/cluster/resolution data may be compiled as training data for training the incident prediction model 146.

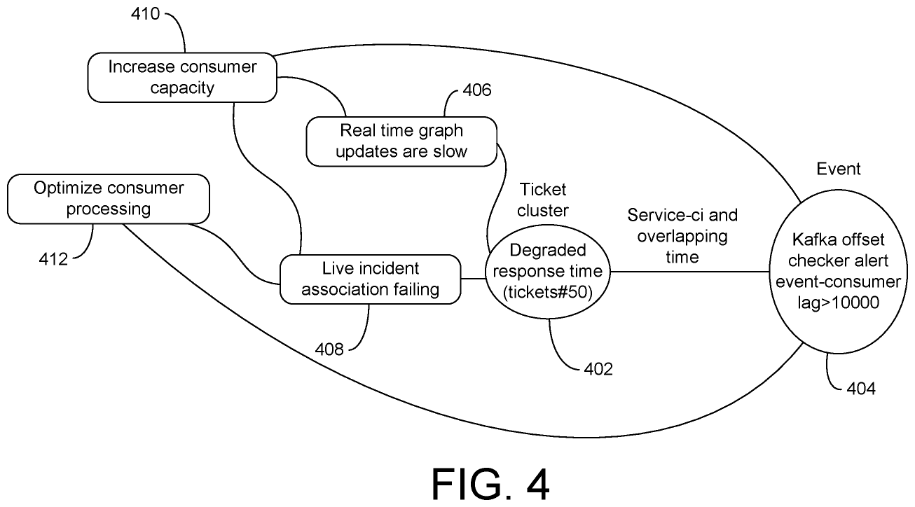

FIG. 4 is a first example knowledge graph generated using the techniques of FIGS. 1-3. The example of FIG. 4, and some following examples, relate to an Apache Kafka system, which is a distributed event store and stream-processing platform that is used, e.g., for website activity tracking, metric monitoring, commit logs, and real-time analytics. It will be appreciated that this example is for illustrative purposes only, and many other example implementations, some of which are referenced below, may be used, as well.

The knowledge graph of FIG. 4, as an example of the knowledge graph 125 of FIG. 1, includes a ticket cluster 402. The ticket cluster 402 is defined with respect to a degraded response time of an implementation of the Kafka system and includes, for example, 50 clustered tickets.

The incident cluster 402 is related to an event 404. As shown, the event 404 relates to an alert or alarm defined to occur as a Kafka offset checker alert event in response to a number of alerts for consumer lag being greater than a threshold, such as 10,000. It will be appreciated that any suitable event may be associated with the incident cluster 402, as described in more detail with respect to FIG. 7. In FIG. 4, the event 404 is related to the event cluster 402 based on corresponding service-ci details and common occurrences within an overlapping time threshold.

A symptom 406 of “Real time graph updates are slow” and a symptom 408 of “Live incident association failing” are derived or determined, e.g., from detailed descriptions and/or worklogs of the 50 tickets of the incident cluster 402. Similarly, a resolution 410 of “Increase consumer capacity” and a resolution 412 of “Optimize consumer processing” may be determined from the resolution fields of the 50 tickets of the incident cluster 402.

As may be understood from the example above of the knowledge graph 125 of FIG. 1, generating the knowledge graph of FIG. 4 enables a generic approach for insight generation from textual fields, including an incident resolution and/or description field(s), or other incident ticket fields or event log fields. Accordingly, it is possible to determine meaningful and actional insights from incidents relating to, e.g., caused by, alerts, or other events determined by a metric monitoring system.

As described with respect to FIGS. 1-3, the knowledge graph of FIG. 4 enables determination of a relationship in the user symptoms (from incident tickets) and IT symptoms (situation(s) mentioned in the relevant events). The knowledge graph of FIG. 4 enables determination of cause(s) and solution(s) of determined symptoms 406, 408, as well as information needed to leverage the ticket data to improve incident handling metrics, such as a mean time to resolve (MTTR). The knowledge graph of FIG. 4 enables determination of a triage plan (including, e.g., questions to ask a current user), ticket analytics beyond problem identification, useful ticket resolution data obtained from the rich but very noisy or unstructured raw resolution data, and FAQs for the type of incident of the incident ticket cluster 402.

The knowledge graph of FIG. 4 enables mapping of the event 404 to the incident cluster 402, and thereby to the symptoms 406, 408, and thus to the resolutions 410, 412 of “Increase consumer capacity” and “Optimize consumer processing.” In more detail, the knowledge graph of FIG. 4 provides a symptom-resolution knowledge graph from event and incident monitoring systems, which assists the incident agent 111 and the system administrator 121 in understanding system health and being able to quickly triage the incidents generated due to event and/or alerts, which is a time-critical task.

The example of FIG. 4 relates to a real-time system that uses Kafka to support real-time updates on dashboards. With the knowledge graph of FIG. 4, the incident agent 111 may quickly understand user symptoms, such as “Real time graph updates are slow,” or “Live incident association is failing” (due to for example, updated objects not getting passed to the system), as well as connected nodes representing past resolutions of “Increase consumer capacity” and “Optimize consumer processing.”

As described herein, the relationship between the incident ticket cluster 402 and the event 404 may be leveraged to determine a causality of the event 404. For example, since the “Degraded response time” incident ticket cluster is formed on the same service-ci and the start and end times also overlap with the “Kafka offset checker alert” critical IT event, the incident ticket and event correlation, and the event and resolution correlations, of FIG. 4 may be established. Also, although a single event is shown, multiple event groups or situations can also be used to connect a symptom from incident tickets to situations (e.g., one or more events) that represent IT-related symptoms and root causes.

Using the relationships of the knowledge graph of FIG. 4 enables correlation of the incident ticket cluster to the IT event “Kafka offset checker”, to thereby correlate the user symptoms with IT events and causality. It is also possible to triage incidents related to this system with complete knowledge from event to incident-cluster, and from incident-cluster to past resolutions, using the knowledge graph of FIG. 4.

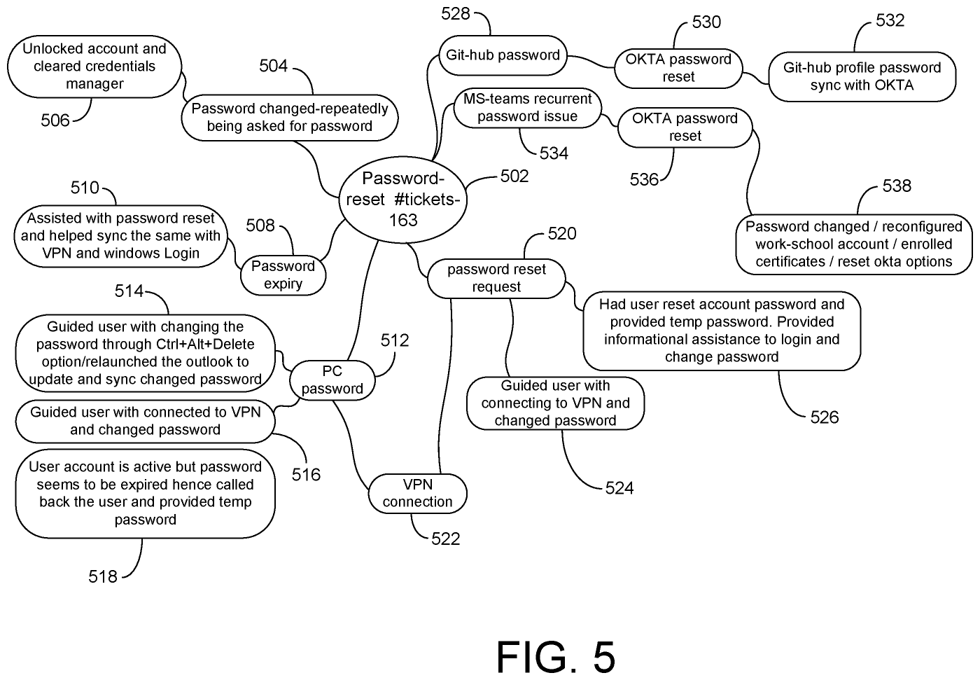

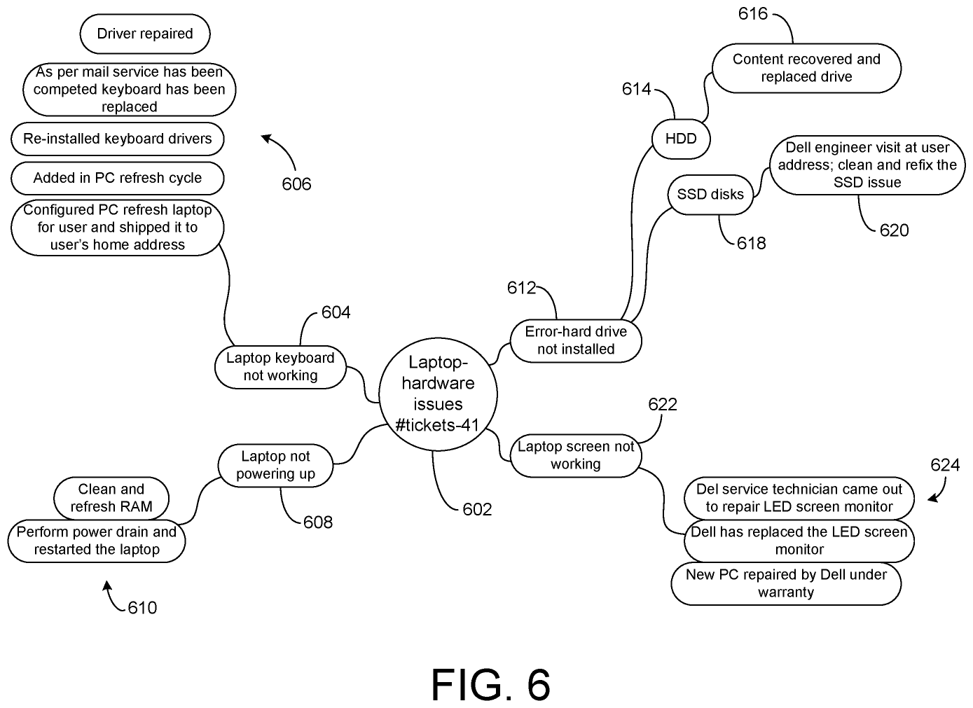

From a voluminous cluster of incidents (e.g., in the range of hundreds or thousands of incidents), it is possible to understand a high-level topic, such as password-reset issues in FIG. 5 or laptop-hardware issues or vm-connection-issues in FIG. 6. However, there are fine-grained insights that are difficult to capture by plain clustering. The knowledge graphs of FIGS. 4-6 enable understanding of fine-grained top-n issues by a specific cluster(s), where “n” represents a user-defined numeric value.

FIG. 5 is a second example knowledge graph generated using the techniques of FIGS. 1-3. The knowledge graph of FIG. 5 provides an example of a ‘password-reset’ cluster 502 that is a collection of 163 incidents related to password issues. Navigating the knowledge graph from the center (with a cluster 502 of 163 incidents), the immediate surrounding topics are the top-n problems or symptoms identified by description insights, e.g., password changed-repeatedly being asked for password 504, password expiry 508, PC password issues 512, a password reset request 520, a Git-hub password problem 528, and a MS-teams recurrent password issue 534. As may be seen, some symptoms lead to additional possible symptoms, such as the PC password 512 and the password reset request 520 both leading to a VPN connection problem 522, and the Git-hub password problem 528 and the MS-teams recurrent password issue 534 both leading to an OKTA (or other authentication/authorization service) password reset, 530, 536 respectively.

Moving from these top-n topics/symptoms in the outward direction of the graph, the top-n resolutions are identified by resolution-insights, including, e.g., unlocked account and cleared credentials manager 506, assisted with password reset and helped sync the same with VPN and windows Login 510, guided user with changing the password through Ctrl+Alt+Delete option/relaunched the outlook to update and sync changed password 514, guided user with connected to VPN and changed password 516, user account is active but password seems to be expired hence called back the user and provided temp password 518, guided user with connecting to VPN and changed password 524, had user reset account password and provided temp password/provided informational assistance to login and change password 526, Git-hub profile password sync with OKTA 532, and password changed/reconfigured work-school account/enrolled certificates/reset okta options 538.

Thus, the knowledge graph of FIG. 5 enables fast automation of solutions like unlocking accounts, resetting of passwords or OKTA options. The knowledge graph of FIG. 5 also provides information regarding the most commonly occurring issues and widely used actionable resolutions. Traversing the paths of the knowledge graph of FIG. 5 also effectively provides a triage plan in terms of how to get to a resolution quickly, as noted above.

FIG. 6 is a third example knowledge graph generated using the techniques of FIGS. 1-3. The knowledge graph of FIG. 6 relates to a cluster 602 related to laptop hardware issues, providing a collection of incidents related to hardware. In FIG. 6, a ‘laptop keyboard not working’ symptom 604 is related to resolutions 606 including driver repaired, as per mail service has been competed keyboard has been replaced, re-installed keyboard drivers, added in PC refresh cycle, and configured PC refresh laptop for user and shipped it to user's home address.

A symptom 608 of ‘laptop not powering up’ is related to resolutions 610 of clean and refresh RAM and perform power drain and restarted the laptop. A symptom 612 of ‘error-hard drive not installed’ is related to further symptom 614 of ‘HDD’ and symptom 618 of ‘SSD disks’, which are related respectively to a resolution 616 of content recovered and replaced drive and a resolution 620 of Dell engineer visit at user address; clean and fix the SSD issue. A symptom 622 of ‘laptop screen not working’ is related to resolutions 624 of Del service technician came out to repair LED screen monitor, Dell has replaced the LED screen monitor, and new PC repaired by Dell under warranty.

With the incident description insights (symptoms 604, 608, 612, 622), the incident agent 111 or system administrator 121 may quickly understand that a majority of the incidents can be categorized as, e.g., booting issues, performance issues, hard-drive installation issues, or screen issues. These categories depict symptoms which help the incident agent 111 and system administrator 121 know the health of the service/application from which the incident(s) emerged. Additionally, paths to resolutions from the incident ticket cluster 602 are established. The knowledge graph of FIG. 6 also illustrates the possibility of establishing FAQs determined from the most important top-n, widely used, actionable, good quality resolutions for the cluster of incidents.

FIG. 7 is a fourth example knowledge graph generated using the techniques of FIGS. 1-3. FIG. 7 illustrates the knowledge graph of FIG. 4 with additional details illustrating operations of the resolution mapper 140 of FIG. 1 in relating incident resolutions to causally related events, for use as the training data 142 to obtain the incident prediction model 146.

Thus, resolution insights may be correlated with a selected and/or correlated event so that the insights may be useful in predicting the impact of the events in the future. Such a correlation may be established in multiple ways. For example, when any event is matched with the ticket cluster based on service-ci and overlapping time window (i.e., strong correlation), insights generated from this ticket cluster may be used to predict the impact of this event on end-user systems and take proactive action.

FIG. 7 illustrates that multiple ticket clusters including the “Degraded Response Time” incident ticket cluster 402 and additional clusters 702, 704 may be defined, each of which may be potentially correlated with one or more of four illustrated events, including the ‘Kafka offset checker alert’ event 404 of FIG. 4, as well as a ‘CPU increased to 92% alert’ event 706, a ‘DB pod slow response alert’ event 708, and a ‘CPU increased to 85% alert’ event 710.

In the example of FIG. 7, all of the events 404, 706, 708, 710 may satisfy an initial correlation criteria with respect to the cluster 402, but not with respect to the clusters 702, 704. Then, the events 404, 706, 708, 710 may be further evaluated to determine individual correlation strengths.

In the example, the event 710 is determined to have a weak correlation strength, while the event 404 is determined to have a strong correlation strength. For example, both events 404, 710 may satisfy a matching overlapping time window criteria, but only the event 404 may also satisfy a matching service-CI criteria. In other examples, the event 404 may occur closer in time within a common overlapping time window criteria than the event 710, or may have overlapping time windows with a larger percentage or number of incidents of the cluster 402, and may therefore be determined to have a stronger correlation with the incident cluster 402. Other correlation criteria and techniques may be used, as well.

Generated resolution insights, such as the resolutions 410, 412 of FIG. 4, provide the top-most widely used and actionable resolution(s) for the ticket cluster, as noted above and shown in FIG. 7. Techniques for determining the resolutions 410, 412 are provided below with respect to FIGS. 8-13.

In general, an impactful resolution may be linked or correlated with the event 404 in multiple ways. For example, the resolution mapper 140 of FIG. 1 may be used to determine whether the resolutions 410, 412 and the event 404 are correlated and have a causal relationship.

For example, in FIG. 7, manual correlation 712 (feedback) may be used. For example, the incident agent 111 may manually link the resolution with the event, which may be tracked as a high confidence, strong correlation relationship.

In other examples, automatic correlation 714 may be used. For example, a text-based relationship may be automatically established. In some specific examples, an event summary of the event 404 and the resolution 410 may be matched using semantic similarity 716 (e.g., cosine similarity), using a suitable threshold, such as a threshold in the range of 0.8 to 1.

In additional or alternative examples, previously correlated events and resolutions may be used to determine a frequency 718 of an event-to-cluster correlation. For example, if the event 404 and resolution 410 are correlated multiple times (e.g., have a high frequency of correlation), this may be considered to be a strong signal to automatically correlate the resolution 410 and the event 404.

In other examples, a large language model (LLM) 720 may be used to implement Natural Language Inference (NLI) and thereby determine whether the resolution and an event summary of the event 404 match with a probability score between 0 and 1. For example, a prompt such as the following may be used:
Identify if this resolution can be used as a remediation for the given event:
Event: <<event description text>>
Remediation: <<resolution text>>
Matching decision: LLM will output a score between 0 and 1 as confidence in the matching.

Training data, such as the training data 142 of FIG. 1, may be generated, which is indicative of how resolution and event text are correlated, along with an associated degree of confidence. Accordingly, rows may be generated that are each defined as (resolution, event, score=1) within the training data. In other words, the above techniques may be used to generate training data of the form (resolution, event, score).

Then, the incident prediction model 146 may be generated as a regression model, or other suitable type of ML model, using (resolution, event, score) as training data with (resolution, event) as the input and the score as output. This approach may be used to determine correlation strength between event summary text and corresponding or correlated resolution text.

Correlating resolution data with event data, as compared to correlating incident text with events, may be particularly useful, e.g., because the resolution of an incident ticket will be more likely to be semantically closer to events. Hence, such similarity, perhaps combined with human feedback, may be leveraged to build out such correlations and generalize the correlations through, e.g., the type of ML regression model referenced above. In contrast, incident text and event text may be quite different, such as when incident or symptom text referencing a user-facing issue such as “latency issue” while correlated event text may be more likely to reference an operational technical issue such as “network switch down”.

Thus, FIG. 7 illustrates that when the Kafka event alert is seen in the future, relevant applications may be identified as being likely to experience “Degraded response time”, which may be proactively addressed using “Increase consumer capacity kafka” 410. This proactive action will prevent or mitigate impact on multiple end users and thereby prevent forming the ticket cluster “Degraded response time” 401.

FIG. 7 further illustrates that the insights and knowledge gained from the knowledge graph of FIG. 7 may be used to generate a user interface 724 that may be provided for the convenience and use of the incident agent 111 or system administrator 121. For example, as shown in the user interface 724, a specific resolution may be displayed in association with correlated events, along with a number of relevant incidents to indicate a strength of the correlation. Although not shown explicitly in FIG. 7, the user interface 724 may include other elements, or links to other elements, such as individual incidents, incident clusters, or individual incident symptoms.

FIG. 8 is a flowchart illustrating example techniques for generating the knowledge graphs of FIGS. 1 and 3-7. FIG. 8 illustrates example processes for generating resolution insights from the resolution fields of incident tickets of an incident ticket cluster. A similar flow(s) may be used to determine insights from other textual fields, such as “incident description” or “action taken.”

For example, as referenced above and illustrated and described in more detail with respect to FIG. 8, in an incident's lifecycle, closure of the incident may be mandated by population of a ‘Resolution notes’ field, which may be a free-flow text field. From n number of incidents in an incident ticket cluster in which there are n+ number of statements in the resolution field, the resolutions or resolution insights of the knowledge graphs of FIGS. 4-7 may be determined as golden sets of resolutions to be quickly applied when a similar incident (or relevant event) occurs in the future.

In the data analysis of such resolution fields, multiple challenges, such as the following, may occur:
Noise—many noisy sentences (auto-resolved, closed, resolved etc.)
Duplication—copy-paste from past incident's resolution field
Semantic duplication (similar meaning resolutions re-worded in a different style (e.g., “installed certificate”, “enrolled certificate”, or “certificate was enrolled”))
Personal style
Assigned templates for resolution data entry

The above and other challenges may result in taking hours to days to identify and understand key resolutions performed to resolve a large set of incidents (e.g., 10-100 incidents in a cluster). FIG. 8 provides a flowchart illustrating techniques for dealing with these and other challenges when identifying resolution insights.

In FIG. 8, cluster 802 is analyzed with respect to a field 804 of included tickets for which insights are desired, such as an issue field or a resolution field, to obtain extracted text 806 from the identified field(s). A statement classifier 808 represents a supervised ML solution to filter bad-quality resolutions. For example, the statement classifier 808 may be trained to filter resolutions having certain words or other content, or having other characteristics, such as too few or too many words or sentences. Semantic de-duplication (perhaps in addition to cosine similarity) may also be used.

Resulting filtered resolution text 810 may be analyzed. Knowledge Base (KB) identifiers (IDs), Uniform Resource Locaters (URLs) or referenced documents (Docs) may be extracted 812.

When a template(s) is known to have been used in constructing relevant resolution notes, template-based resolution statements may also be identified and extracted 814. For example, service desk agents may follow some language phrase patterns and/or styles and templates while entering resolution notes.

The following are template examples:
“This issue is resolved, and steps followed are: . . . ”
“Resolution: Check certificate enrollment and update the certificate”
“Issue: Internet connection slow with VPN, Raised By: PersonA,
Resolution:Performed netshwinsock.” In this case, a template is depicted in which the incident agent fills in template fields such as Issue, Raised By, Resolution.

While extracting resolutions, custom templates and/or styles may be supported. Example algorithms may pick up relevant data from fields and/or sections like ‘steps followed’ or ‘Resolution’. When a resolution field is empty or not meaningful, a worklog may be used to get resolutions.

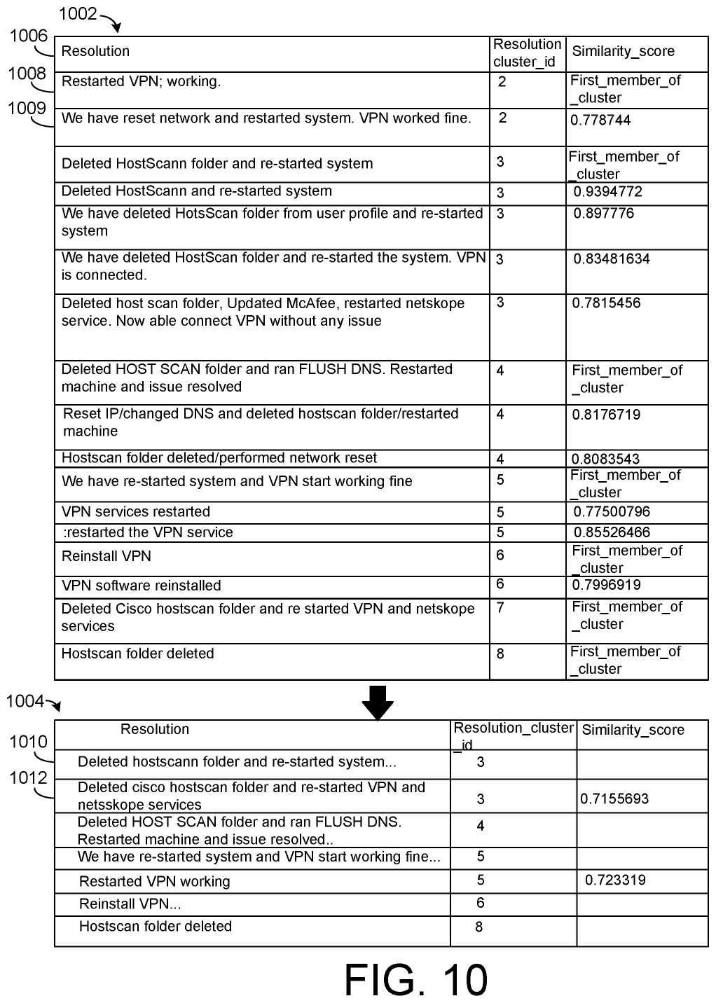

Then, a multi-level paraphrase mining technique may be performed, as described in more detail below with respect to FIG. 10. As shown, a first paraphrase mining 816 may be performed using a relatively high-similarity threshold, and then a second, deep paraphrase mining 818 may be performed using a relatively low threshold. As described below, such an approach is more likely to inclusively identify relevant, related resolutions using the initial, higher-similarity threshold, while ensuring a high degree of similarity within resulting, identified statement sets 820.

An identification 822 of relevant statements may be made, using a domain ontology that is specific to the technology landscape 104. For example, instances of known IT objects and IT action verbs may be identified for use in further stages of processing.

Deep semantically similar statements from the cluster 802 of incidents may be determined using, e.g., customized ranking 824. Specific examples of ranking techniques may include, e.g., determining the importance of each resolution using the IT domain ontology, presence of relevant Knowledge Base articles or other sources, a rated skill-level of the relevant agent, an average priority of the incidents corresponding to a statement being ranked, or a number of incidents using the statement being evaluated.

Ranking 824 may be performed using one or more ranking algorithms including seeding a set of weights per sentence that takes into consideration an assigned or determined importance of each sentence. The sentence importance or score is determined by multiple factors such as a number tickets associated with each resolution, whether the resolution includes IT objects and/or actionable verbs, whether the resolution was written by an agent with a high-skill rating, a number of tickets, and priority of tickets in which this sentence was used in corresponding resolutions. Custom fields and weights may be accommodated, e.g., injected to influence ranking based on a domain specification (e.g., time spent on a critical ticket).

In determining rankings, an IT domain ontology may be used, which may be similar or the same as the domain ontology used during the identification 822 of relevant statements. For example, a dictionary of IT object and IT action verbs, each assigned an importance value between 0 and 10, may be used. For example, IT objects may include {VPN, Office, server, machine, . . . }, and IT action verbs may include {Reboot, restart, enroll, delete, update, config, . . . }. Named Entity Recognition (NER) entities in IT may be recognized from the description field of each ticket. For example, “Cannot connect to VPN” will detect the named entity noun “VPN.”

Sentence scores may be determined using various techniques. For example, an ontology may be used to determine whether a sentence has one or more IT objects and one or more IT action verbs, in which case their respective scores may be added. Inclusion of, or reference to, a KB article in a sentence, may increase a score of that sentence with respect to the Score (KB article) ranking factor. If a sentence was written by an experienced agent, then the sentence may have an increased weighting. Other ranking factors may include, e.g., a ticket context, an average priority of tickets a sentence is associated with, and/or a number of tickets in which a sentence is found as a resolution.

Then, as an example, a sentence weight may be determined as:

Weight(sentence)=wt1*Sum(Score(obj-1)+Score(obj-2)+ . . . )+wt2*Sum(score(verb-1)+score(verb-2)+ . . . )+wt3*Sum(Kbarticles)+wt4*(Agent-skill)+wt5*(Avg-tkt-priority)+wt6*(#Incidents)
where wt1, wt2, wt3 . . . are tunable weights.

Examples of scored/ranked sentences and associated ranking score may include: score_resolution_tuples: [(0.3750876923298896, ‘Cisco certificate enrolled’), (0.3546534750368219, ‘user certificate enrolled’), (0.13733293716200332, ‘Guided user’), (0.13292589547128517, ‘issue is solved by contacting user’)]. As may be observed, the score of the most relevant sentence ‘Cisco certificate enrolled’ (0.3750876923298896) is better than irrelevant resolution sentences such as ‘Guided user’ and ‘issue is solved by contacting user’.

Ranked statement sets 826 may thus be processed for anonymization 828, to obtain quality resolution statements at the cluster level 830. For example, incident agent(s) 111 may mention or include persons' names, email IDs, or other sensitive personal identifiable information, which may be removed before determining final resolution insights.

Feedback 832, whether positive or negative, may also be collected from incident agent(s) 111 with respect to the generated resolution insights for individual resolutions of the top_n resolutions set, as shown in table 834. As shown in the table 834, determined resolution insights, associated with corresponding incident clusters, may be stored with knowledge sources and/or other relevant information, along with explicit feedback from incident agent(s) 111 and implicit feedback inferred from context, such as a total number of usages.

Feedback may be incorporated at, or in conjunction with, the ranking 824, such as when a cluster being analyzed for resolution insights generation is selected. Similarity between the past cluster(s) and the current cluster (e.g., at the description/summary level) may be used to determine the current resolution insights. The ranking mechanism may be used to lower a resolution's rank when the resolution has received negative feedback and its implicit usage count is lower among the set of other similar resolutions.

FIG. 8 illustrates example processing results 836 and 838 for the processes of FIG. 8. For example, as shown, processing results 836 relate to a cluster corresponding to an issue of “vpn-password-change,” which includes 60 incidents and 84 total resolution statements. Resulting resolution insights includes identification of knowledge sources (Knowledge Sources:kbe00018019), as well as ranked resolution statements that are each associated with corresponding, individual incidents. As a matter of notation, incidents are labeled as “in”, where “i” represents an incident and “n” represents the number assigned to that incident. Therefore, ranked resolution statements include: New vpn certificate enrolled {i33,i37,i48,i9,i59,i17,i14,i25,i11,i13,i56,i49,i5,i12,i41,i53}, Mcafee has been updated: {i20,i39}, Device rebooted able to login, asked to clear old saved logins agreed {i42}, Reinstalled crowd strike restarted services for netskope cisco any connect secure mobility agent services {i7}, Network reset {i29}, Account unlocked {i52}, and Followed kba00018019 and issue resolved {i47}.

Similarly, in the results 838, a cluster corresponding to an issue of “vpn-slow-internet,” includes 5 incidents and 7 total resolution statements. Resulting resolution insights includes identification of knowledge sources, if any, as well as ranked resolution statements that are each associated with corresponding, individual incidents. In the example of results 838, ranked resolution statements include: Performed netsh winsock reset, netsh int ip reset & ipconfig/flushdns command {i1,i3}, DNS cache cleared {i4}.

The above-described algorithm(s) may be used to generate the types of FAQs and Knowledge Graph(s) described with respect to FIGS. 1-7. For example, a knowledge graph may include the types of cluster nodes, symptom nodes, and resolution nodes, described above, and may also include other node types, such as a ticket node or a service node.

Example steps to generate FAQ and/or Knowledge Graph may include:
1. Run Insights Generation algorithm on Description field to create [(cluster node) - - - (Symptom node)] subgraph
2. Run Insights Generation algorithm on Resolution field to create [(cluster node) - - - (Resolution node)] subgraph
3. Connect (Symptom node) - - - (Resolution node) when connected to the same incident.
4. Receive IT events from a monitoring system (and optionally group multiple events into individual situations) to generate IT symptoms/cause event nodes.
5. For each IT ticket cluster, correlate events with the same service-CI as the ticket cluster and occurring with an overlapping time window to connect (cluster node) - - - (IT event node).

Thus, described techniques enable tracking of an individual (Ticket node) - - - (Symptom node) correspondence, as well as (Ticket node) - - - (Resolution node) correspondence. Using transitive closure, as illustrated and described with respect to FIGS. 1, 3, 4, and 7, (Symptom node) - - - (Resolution node) connections may be made. The resulting nodes may be used to answer questions such as, “What are the common problems for VPN?” and “What are the resolutions for VPN connectivity issue?”

(Ticket node) may also be connected to (IT event node), which enables connection of user issues to IT issues to IT symptoms or events as shown in the examples of FIGS. 1, 3, 4, and 7. For example, the examples of FIG. 7 may answer questions such as: “What are the IT events that cause user symptoms?”, or “What is the root cause in IT?” to obtain an event-based answer such as (Kafka queue full, router down).

For FAQ generation, the knowledge graph may be traversed per cluster and all the ranked resolutions may be listed. This forms the basis of a FAQ that identifies list of solutions. The FAQ can be generated at a (Symptom) level for more granular and specific resolutions. This includes not only user symptoms but also IT symptoms and causality from events.

Triage questions can be generated for each (cluster node). For example, (cluster node) - - - (Symptom node) includes multiple descriptions reflecting the slight variation in the general problem area or context. These relationships may be used by the incident agent to pick different descriptions, e.g., by understanding the right questions to ask. A dialog flow can be generated from this KG.

A prompt between issues may be built, and a LLM may be used to find out the difference between symptom nodes and generate a list of differences that can be asked for triage. In the use case below, both location and connectivity may be used as a basis for two possible triage questions.

For example, the LLM prompt may be stated as “Identify key differences in between these two issues, issue 1 and issue 2.” Issue 1 is a “VPN connectivity issue when working from outside of your home.” For example, VPN does not work from hotels or other outside places. Issue 2 is a “VPN issue where you cannot connect from home.

Then, the key differences between Issue 1 and Issue 2 may be described as follows:
Location: Issue 1 is related to connecting to VPN from outside of the home, while Issue 2 is related to connecting to VPN from home.
Connectivity: In Issue 1, the problem is that the VPN does not work from hotels or other outside places, while in Issue 2, the problem is that the VPN cannot connect from home.
Possible Causes: The possible causes of Issue 1 could be network restrictions, firewall settings, or internet connectivity issues in the location where the user is trying to connect from. On the other hand, the possible causes of Issue 2 could be issues with the VPN client software, network connectivity issues, or firewall settings on the home network.
Troubleshooting: The troubleshooting steps for Issue 1 may involve checking network connectivity, firewall settings, and contacting the IT support team of the VPN service provider. For Issue 2, the troubleshooting steps may involve checking the VPN client software settings, resetting the home network, or contacting the IT support team of the VPN service provider.

Thus, while both issues relate to VPN connectivity problems, Issue 1 is related to connecting from outside of the home, while Issue 2 is related to connecting from home. The causes and troubleshooting steps for each issue may also differ.

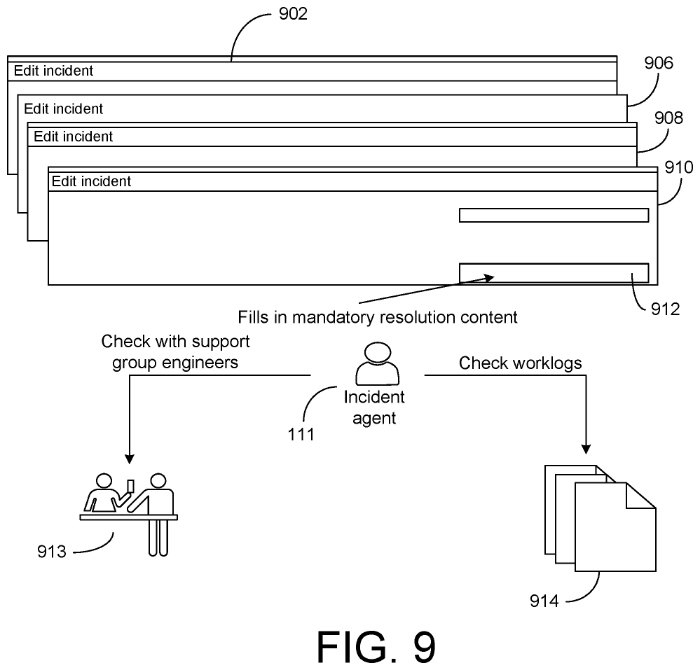

FIG. 9 illustrates an example context for implementation of the resolution generator 134 of FIG. 1. FIG. 9 illustrates a first incident ticket 902 having a corresponding worklog (not visible in FIG. 9). FIG. 9 further illustrates additional incident tickets 906, 908, 910.

The incident agent 111 may be required to handle a large plurality of incident tickets 106, represented by the incident tickets 902, 906, 908, 910 of FIG. 9. For each incident ticket, for example, 910, the incident agent 111 may be required to fill in a resolution field 912 with one or more resolution statements describing actions taken for successful resolution of the incident.

During the process of resolving incident tickets 902, 906, 908, 910, significant worklogs, represented by worklogs 914, may be accumulated. Moreover, the incident agent 111 may consult with other incident agents 111 or support group engineers 913 and take various other actions in attempting to reach ticket resolution.

Once resolution is achieved, the incident agent 111 may attempt to complete the mandatory task of filling in the resolution field 912. As noted above, and as represented in FIG. 9, the incident agent 111 likely has a number of parallel or simultaneous incident tickets at various stages of resolution, including newly received tickets for which users are waiting for assistance.

Consequently, it is extremely difficult for the incident agent 111 to take the time to provide a concise and complete resolution statement for the resolution field 912. In conventional systems, the incident agent 111 may simply add a perfunctory remark or other statement to the resolution field (e.g., “resolved” or “closed”), so as to technically fulfill the requirement to fill in the resolution field 912. In other examples, many noisy or unhelpful sentences may be included. In other examples, lexical duplication (e.g., copy-paste from past incident's resolution field) or semantic duplication (resolutions with similar meaning re-worded in a different style) may be present. For example, lexical duplication may include “installed certificate”, “enrolled certificate”, or “certificate was enrolled”. Semantic duplication may include “MS office reinstalled” and “Microsoft Word installed”.

When the correlation manager 102 of FIG. 1 is available, the resolution generator 134 may automatically generate a resolution captured in the node of the knowledge graph 125 shown as resolution 128. In such cases, the incident agent 111 may be provided with one or more actionable resolutions, which the incident agent 111 may have the option of moderating or revising. Accordingly, the incident agent 111 may be able to provide faster and more accurate service to a user submitting for example, the incident ticket 910 of FIG. 9 and may be relieved of some or all of the responsibility of determining proper content for, and filling in, the resolution field 912.

Thus, from n number of incidents in a cluster where there are n+ number of statements in the resolution field, as in the example of FIG. 9, the techniques of FIG. 8, as well as FIGS. 10-13, may be used to detect an optimal set of processed resolution statements that can be quickly applied when a similar incident occurs in the future.

FIG. 10 illustrates example techniques for implementing the flowchart of FIG. 8, including performing paraphrase mining on resolution statements of FIG. 9. In FIG. 10, as shown in a first table 1002, paraphrase mining may be used to remove or combine semantically similar resolutions from a cluster of incidents.

More specifically, sentence embeddings may be generated for each resolution, and then each resolution may be compared with a remainder of the resolutions from that cluster (using the embeddings) to thereby return pairs that have highest similarity scores (e.g., above a first similarity threshold). Duplicate resolutions may be filtered to get a unique set of resolutions for a specific cluster.

For example, as shown in FIG. 10, the table 1002 includes a first row 1006 that identifies a column for Resolution(s), an identification of a corresponding cluster_id, and a similarity_score. The example of the table 1002 assumes a set of unique resolutions for an incident cluster is:
[
restarted VPN; working.
We have reset network and restarted system. VPN worked fine.
Deleted HostScann folder and re-started system
Deleted HostScann and re-started system.
We have deleted HostScan folder from user profile and re-started system.
We have deleted HostScan folder and re-started the system. VPN is connected.
Deleted host scan folder, Updated McAfee, Restarted Netskope service. Now able to connect VPN without any issue
Deleted HOST SCAN folder and ran FLUSH DNS. Restarted machine and issue resolved.
Reset IP/changed DNS and deleted hostscan Folder/restarted machine
Hostscan folder deleted/performed network reset
We have re-started system and VPN start working fine
VPN services restarted
: restarted the VPN service
Reinstall VPN
VPN software reinstalled
Deleted Cisco hostscan folder and re started VPN and netskope services
Hostcan folder deleted
]

Executing a first level of paraphrase mining for the above resolutions of the table 1002, and with a first similarity threshold (e.g., 0.75), creates the table 1002 of FIG. 10. For example, in a row 1008, a resolution of “Restarted VPN; working” relates to resolution cluster_id 2 and is identified as the first member of a cluster. Then, a second resolution statement in a row 1009 of “We have reset network and restarted system. VPN worked fine” is determined to have a similarity score of 0.778744 and to be part of the same resolution cluster_id 2. Similar operations are reflected in a remainder of the table 1002, for resolution cluster_id 3, 4, 5, 6, 7, and 8 and associated cluster members.

Then, deep paraphrase mining may be applied to get more distinct resolutions, as reflected in the table 1004 of FIG. 10. This deep paraphrase mining runs on the output of the just-described first level paraphrase mining of the table 1002, but with a second similarity threshold that is lower than the first similarity threshold.

For example, applying a second level of deep paraphrase mining on the table 1002 with a second, lower similarity threshold (e.g., 0.7) provides the table 1004 of FIG. 10. As shown there, a row 1010 includes the resolution statement of “Deleted HostScann and re-started system,” associated with resolution cluster_id 3 of the table 1002. The resolution cluster_id 3 then includes a similar resolution statement “Deleted Cisco hostscan folder and re started VPN and netskope services”, with a similarity_score of 0.7155693.

By setting the first similarity threshold relatively high, improved incident ticket clusters are obtained, because the clusters are not polluted with dissimilar resolutions. In other words, it may be beneficial to create clusters with higher threshold first and then apply deep paraphrase mining with slightly lower threshold among the first level clusters. In this way, the first-level paraphrase mining captures the distinctive differences, and maintains a higher-level difference before deep paraphrase mining starts merging sets that are lexically different but semantically similar.

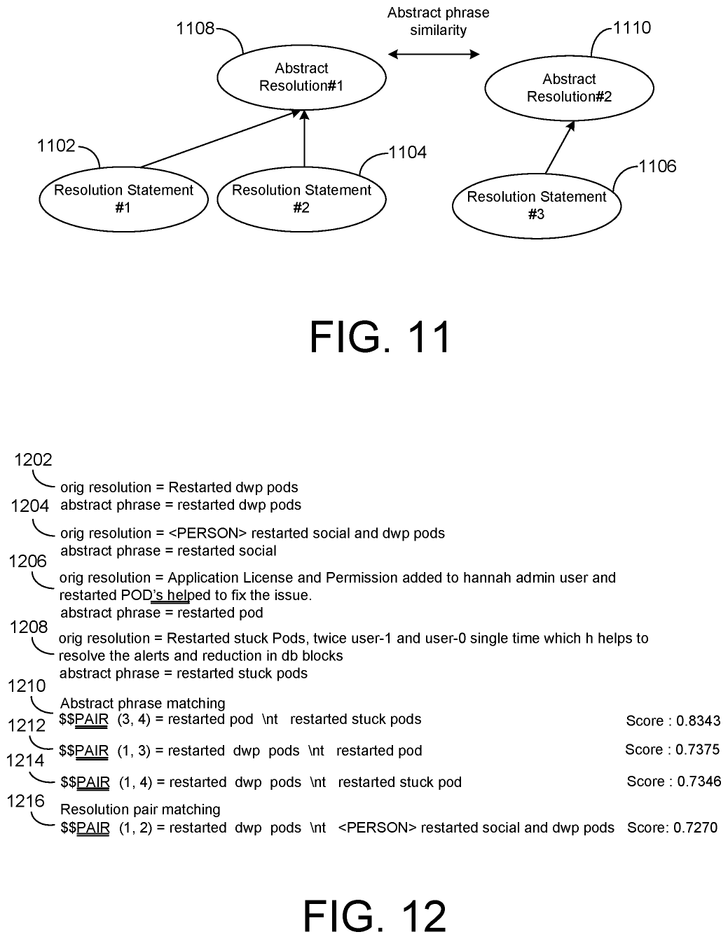

FIG. 11 is a block diagram illustrating a first example of resolution statement analysis. FIG. 11 illustrates a concept of abstract merging, in which multiple resolution statements 1102, 1104, 1106 are analyzed to determine an abstract resolution(s) that is common to some or all of the resolution statements. For example, an abstract resolution 1108 may be constructed as having resolution statements inheriting from root-class resolution 1102, resolution 1104. Similarly, one or more other resolution statements represented by resolution statement 1106 may be abstracted to obtain an abstract resolution 1110. Then, as shown, abstract phrase similarity between the abstract resolution statements 1108, 1110 may be judged/compared relative to a threshold.

Thus, using abstract merging, it is possible to understand higher-level concepts for each of the resolution statements, so that similarity comparisons may be made on those concepts or abstracted phrases. This process may ensure that similar resolutions are merged even though their words overlap, or semantic similarity is not high. In other words, for example, even if a cosine-similarity between a first resolution statement, second resolution statement, and third resolution statement is not high, a similarity between corresponding abstracted resolution statements may be sufficient to indicate that the various resolution statements should be merged.

Various techniques may be used to obtain abstract representations 1108, 1110 of one or more resolution statements 1102, 1104, 1106. For example, an LLM summarization may be used. An IT domain ontology may be used to identify an IT object and IT action verb for phrase extraction. Phrase extraction may also be performed using other ML models, such as key phrase extraction models.

In FIG. 12, original resolutions are the outputs of paraphrase mining processes similar to those of FIG. 10. The semantic similarity score between sentences may be relatively low, but corresponding abstract phrases are very similar.

More specifically, in the example of FIG. 12, distinct resolutions from paraphrase mining are provided. As shown, similarity (and subsequent merging) may be determined based on abstracted resolutions and/or on actual statement similarity.

For example, in example 1202, an original resolution of “Restarted dwp pods” abstracts to an abstract phrase “restarted dwp pods”. In example 1204, an original resolution of “<PERSON> restarted social and dwp pods” abstracts to an abstract phrase “restarted social”. In example 1206, an original resolution of “Application License and Permission added to hannah admin user and restarted POD's helped to fix the issue” abstracts to an abstract phrase “restarted pod”. In example 1208, an original resolution of “Restarted stuck Pods, twice user-1 and user-0 single time which h helps to resolve the alerts and reduction in db blocks” abstracts to an abstract phrase “restarted stuck pods”.

Then, abstract phrase matching 1210 may relate the abstracted phrases above on a pair-wise basis to determine similarities at the abstracted phrase level. As shown in FIG. 12, for purposes of the abstract phrase matching 1210, the above examples are notated as (Example 1202=1, Example 1204=2, Example 1206=3, and Example 1208=4). Similarity scores are calculated and ranked to determine the relative levels of pairwise similarity for the various abstracted resolution phrases.

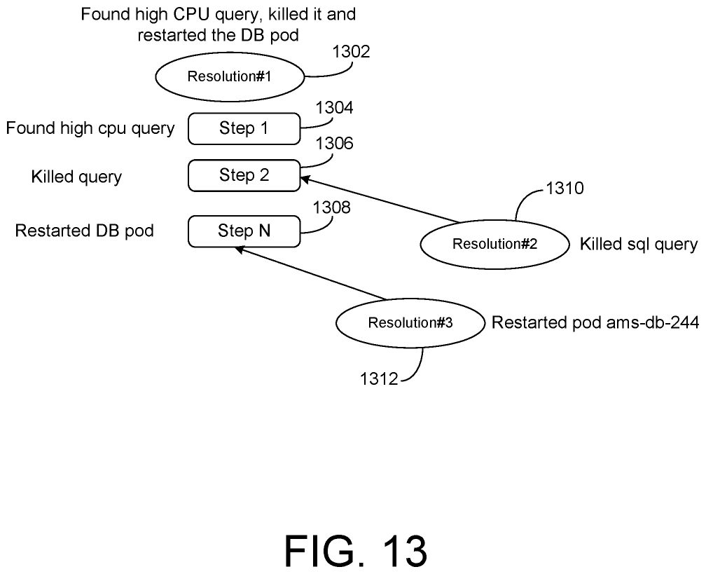

FIG. 13 is a block diagram illustrating a third example of resolution statement analysis, for multi-step resolutions. For example, some resolutions may have multiple steps, while others each have a single step. Splitting multi-step resolutions into individual statements or sentences may enable resolutions to have a parent-child relationship, as shown in FIG. 13.

Specifically, in FIG. 13, a resolution 1302 includes “Found high CPU query, killed it and restarted the DB pod”, with included individual resolution statement 1304 of “Found high CPU query”, resolution statement 1306 of “Killed query”, and resolution statement 1308 for “Restarted DB pod”. This analysis of the resolution 1302 enables merging between individual resolution statements 1306, 1308 of the resolution statement 1308 with other resolution statements 1310, 1312, respectively, of other resolutions.

Described techniques enable generation of multi-level ranked lists of resolutions such as by service, by cluster, or by symptom, which may be used in FAQ generation. Described techniques enable generation of a knowledge graph that provides a resolution path to identify a triage plan to get from symptom to resolution. Further, described techniques enable a combination of monitored events with incident ticket symptoms in order to connect, and ultimately predict, incident symptoms/resolutions to/from system events, such as when a “router down” IT event is linked to a “slow user interface” incident.

Thus, resolution insights are provided that identify prominent incidents and corresponding prominent resolutions. A mean time to resolve (MTTR) for incidents may be reduced, and incident/resolution patterns may be identified. Further, knowledge sources analytics may be provided. For example, recommended resolutions may be used to identify any specific cluster's resolutions that have not used knowledge articles, and thereby identify a candidate cluster for creating a knowledge base.

Since insights are generated on clusters of incidents, recommended resolutions may be used for training purposes or FAQ generation in service desk management. Moreover, correlations determined from insights based on multiple textual fields of incident tickets may be determined, which further enhances a knowledge of an incident agent 111 or system administrator 121 with respect to the incident ticket cluster(s).

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatuses, e.g., a programmable processor, a computer, a server, multiple computers or servers, mainframe computer(s), or other kind(s) of digital computer(s). A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
receive, from an incident handling system, a plurality of resolved incident tickets of a technology landscape;
receive, from a metric monitoring system monitoring the technology landscape, a plurality of events;
generate, from the plurality of resolved incident tickets, an incident cluster having related incidents;
identify, for the incident cluster, a correlated event of the plurality of events;
store the correlated event with an incident resolution obtained from the incident cluster, to obtain labeled training data;
train a machine learning (ML) model with the labeled training data to obtain an incident prediction model; and
process a new event with the incident prediction model to provide a predicted incident and a predicted resolution.

2. The computer program product of claim 1, wherein the instructions, when executed, are further configured to cause the at least one computing device to:
determine a symptom that is common to at least some of the incidents of the incident cluster.

3. The computer program product of claim 2, wherein the instructions, when executed, are further configured to cause the at least one computing device to:
determine the incident resolution as being common to at least some of the incidents of the incident cluster.

4. The computer program product of claim 3, wherein the instructions, when executed, are further configured to cause the at least one computing device to:
generate, for the incident cluster, a corresponding knowledge graph that includes an incident cluster node connected to at least one symptom node that represents the symptom and that is connected to at least one resolution node representing the resolution.

5. The computer program product of claim 4, wherein the instructions, when executed, are further configured to cause the at least one computing device to:
generate the knowledge graph with an event node representing the correlated event being linked to the at least one resolution node.

6. The computer program product of claim 1, wherein the instructions, when executed, are further configured to cause the at least one computing device to:
identify the correlated event based on an occurrence of the correlated event and at least one incident of the incident cluster within an overlapping time window.

7. The computer program product of claim 1, wherein the instructions, when executed, are further configured to cause the at least one computing device to:
store the correlated event with the incident resolution within the labeled training data with a score characterizing a strength of correlation of the event; and
train the ML model using the correlated event and the incident resolution as input and the score as output.

8. The computer program product of claim 7, wherein the instructions, when executed, are further configured to cause the at least one computing device to:
determine the score based on a semantic similarity between resolution statements of the incident resolution and an event summary of the correlated event.

9. The computer program product of claim 7, wherein the instructions, when executed, are further configured to cause the at least one computing device to:
determine the score based on a frequency of correlation of the incident resolution with the correlated event within the event cluster.

10. The computer program product of claim 7, wherein the instructions, when executed, are further configured to cause the at least one computing device to:
determine the score based on a comparison of the incident resolution and the correlated event that is provided by a large language model (LLM).

11. A computer-implemented method, the method comprising:
receiving, from an incident handling system, a plurality of resolved incident tickets of a technology landscape;
receiving, from a metric monitoring system monitoring the technology landscape, a plurality of events;
generating, from the plurality of resolved incident tickets, an incident cluster having related incidents;
identifying, for the incident cluster, a correlated event of the plurality of events;
storing the correlated event with an incident resolution obtained from the incident cluster, to obtain labeled training data;
training a machine learning (ML) model with the labeled training data to obtain an incident prediction model; and
processing a new event with the incident prediction model to provide a predicted incident and a predicted resolution.

12. The method of claim 11, further comprising:
determining a symptom that is common to at least some of the incidents of the incident cluster;
determining the incident resolution as being common to at least some of the incidents of the incident cluster; and
generating, for the incident cluster, a corresponding knowledge graph that includes an incident cluster node connected to at least one symptom node that represents the symptom and that is connected to at least one resolution node representing the resolution, with an event node representing the correlated event being linked to the at least one resolution node within the knowledge graph.

13. The method of claim 12, further comprising:
storing the correlated event with the incident resolution within the labeled training data with a score characterizing a strength of correlation of the event; and
training the ML model using the correlated event and the incident resolution as input and the score as output.

14. The method of claim 13, further comprising:
determining the score based on a semantic similarity between resolution statements of the incident resolution and an event summary of the correlated event.

15. The method of claim 13, further comprising:
determining the score based on a frequency of correlation of the incident resolution with the correlated event within the event cluster.

16. The method of claim 13, further comprising:
determining the score based on a comparison of the incident resolution and the correlated event that is provided by a large language model (LLM).

17. A system comprising:
at least one memory including instructions; and
at least one processor that is operably coupled to the at least one memory and that is arranged and configured to execute instructions that, when executed, cause the at least one processor to:
receive, from an incident handling system, a plurality of resolved incident tickets of a technology landscape;
receive, from a metric monitoring system monitoring the technology landscape, a plurality of events;
generate, from the plurality of resolved incident tickets, an incident cluster having related incidents;
identify, for the incident cluster, a correlated event of the plurality of events;
store the correlated event with an incident resolution obtained from the incident cluster, to obtain labeled training data;
train a machine learning (ML) model with the labeled training data to obtain an incident prediction model; and
process a new event with the incident prediction model to provide a predicted incident and a predicted resolution.

18. The system of claim 17, wherein the instructions, when executed, are further configured to cause the at least one processor to:
determine a symptom that is common to at least some of the incidents of the incident cluster;
determine the incident resolution as being common to at least some of the incidents of the incident cluster; and
generate, for the incident cluster, a corresponding knowledge graph that includes an incident cluster node connected to at least one symptom node that represents the symptom and that is connected to at least one resolution node representing the resolution.

19. The system of claim 17, wherein the instructions, when executed, are further configured to cause the at least one processor to:
identify the correlated event based on an occurrence of the correlated event and at least one incident of the incident cluster within an overlapping time window.

20. The system of claim 17, wherein the instructions, when executed, are further configured to cause the at least one processor to:
store the correlated event with the incident resolution within the labeled training data with a score characterizing a strength of correlation of the event; and
train the ML model using the correlated event and the incident resolution as input and the score as output.
